(19) United States
(12) Patent Application Publication
(10) Pub. No.: US 2006/0060677 A1
(43) Pub. Date: Mar. 23, 2006

(54) Device in the form of a rotary carousel for application by spraying of a colouring and/or treatment product

(75) Inventor: Pierre Louis Giraud, Audincourt (FR)

Correspondence Address: GREENBLUM & BERNSTEIN, P.L.C., 1950 ROLAND CLARKE PLACE, RESTON, VA, 20191, US

(73) Assignee: DISA CATTINAIR, Pont De Roide (FR)

(21) Appl. No.: 11/105,555

(22) Filed: Apr. 14, 2005

(30) Foreign Application Priority Data
Sep. 10, 2004 (FR) 04 09619

(51) Int. Cl. B05B 7/08

(52) U.S. Cl. 239/549; 239/305

(57) ABSTRACT

A rotary carousel device for spraying a coloring and/or treatment product, that includes at least one rotary support rotatably driven by a motorized device on at least one chassis around a rotational axis. Further, one or more spraying devices are in communication with a pressurized feeding system composed of at least one pump and a set of feeding pipes. The set of feeding pipes comprises an on-board pipework arranged on the rotary carousel device, and an external pipework arranged to link the on-board pipework and at least one product tank. A fitting or rotary seal connection system is mounted on the rotational axis, connecting the on-board pipework and the external pipework. Wherein the at least one pump being arranged on the rotary carousel device and being coupled to the external pipework and to the on-board pipework, to provide the product to a desired pressure at the spraying device.

### CROSS-REFERENCE TO RELATED APPLICATIONS

The present application claims priority under 35 U.S.C. §119 of French Patent Application No. 04 09619, filed on Sep. 10, 2004, the disclosure of which is expressly incorporated by reference herein in its entirety.

### BACKGROUND OF THE INVENTION

1. Field of the Invention

The invention relates to a device in the form of a rotary carousel for application by spraying of a coloring and/or treatment product. The invention is an improvement made to conventional spraying devices including a carousel-type motorized rotary support, fitted with a spraying device associated with a pressurized product feeding system having a set of feeding pipes and pumping devices.

2. Discussion of Background Information

The spraying devices as mentioned above, may be used for the application of paint or varnish on bodies of any nature. These spraying devices include a set of pipes formed conventionally of an on-board pipework, provided on the rotary carousel and, of an external pipework, linking the on-board pipework and a product tank. Further, the on-board and external pipes are connected by a fitting or rotary seal-type connection system, mounted on the axis of the carousel.

Spraying may be administered by known application devices having at least one added pump at the external pipework, wherein the product to be sprayed is pressurized in the external pipework, upstream of the connection system between the on-board and external pipes.

Still, most current rotary connection systems (seals or rotary fittings) are not capable of sustaining high pressures in the product, and eventually fail, resulting in shortening the durability life of the product. In particular, this problem occurs when operating the device at high pressure, i.e. when applying pressures above 40 to 50 bars.

Consequently, the current application devices mentioned above are limited in terms of increase in pressure of the product to be sprayed, mainly due to the structural features of the integrated connection system.

The present invention intends to remedy such shortcomings by providing a modification in the structure of the known application devices, offering the opportunity to increase the pressure of the product to be sprayed, without any limitation linked with the integrated connection system or reducing the durability life of the connection system as mention above.

### SUMMARY OF THE INVENTION

The present invention provides a rotary support in the form of a carousel, driven into rotation on a chassis around an axis by a motorized device. The rotary carousel is fitted with a spraying device associated with a system for feeding a pressurized product including a set of feeding pipes and pumping devices. The set of pipes may be formed of an on-board pipework, provided on the rotary carousel, and of an external pipework, that provides the link between the on-board pipework and a product tank. Further, the on-board and external pipes are connected by a fitting or rotary seal-type connection system mounted on the rotational axis of the carousel.

According to the invention, a feeding system includes at least one pump on-board the rotary carousel connected to the external pipework by pipes of the connection system, and they are connected to the on-board pipework to bring the spraying device to the requisite pressure to spray the product.

According to another feature of the invention is to supply the spraying device with high pressure (in this case, a pressure of at least 40 or 50 bars) via high pressure pipework to spray the product, using high pressure on-board pump(s) that link between the pump(s) and the spraying device.

In a preferred embodiment of the invention, the spraying device can befitted with a single on-board pump, wherein the suction member is mounted along the rotational axis of the rotary carousel.

According to an alternate embodiment according to the invention, the on-board pump(s) are added to the rotary carousel with their suction member and their center of gravity out of alignment with respect to the rotational axis of the carousel. In such a case, if at least two on-board pumps are used, they are advantageously evenly distributed around the rotational axis of the carousel, to ensure the rotational balance thereof.

For a single on-board pump, the connection system between the external pipework and the on-board pump will be of a single-channel rotary fitting type. For a plurality of on-board pumps, the connection system may include of a multi-channel rotary fitting.

According to another feature of the invention, the device comprises only a low pressure, so-called “supercharging pump” (operating for example at pressures of the order of 1 to 4 bars), associated with the external pipework and supplying the treatment product to the on-board pump(s) on the rotary carousel.

According to another feature of the invention, the rotary carousel is fitted on its periphery with a plurality of radial or radiated arms, fitted at their free ends with spraying device means guns actuated by solenoid valves.

According to another feature of the invention, the gunning cabin may include at least one spraying device as described above.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective overview of a device according to the invention, fitted with an on-board pump mounted on the rotational axis of the rotary carousel;

FIG. 1 is a perspective overview of an embodiment variation of FIG. 1 wherein two on-board pumps are used, arranged on both sides of the rotational axis of the carousel.

### DETAILED DESCRIPTION OF THE PRESENT INVENTION

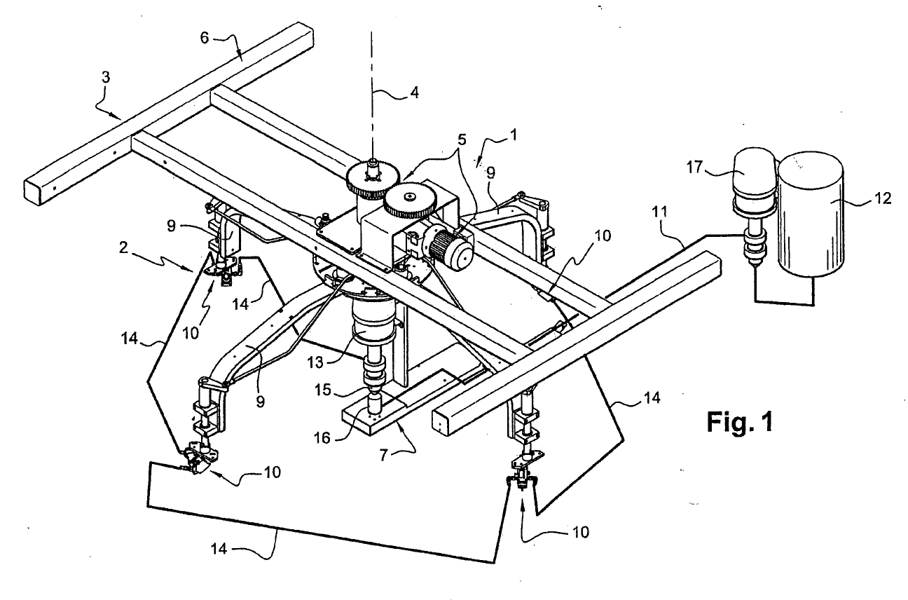

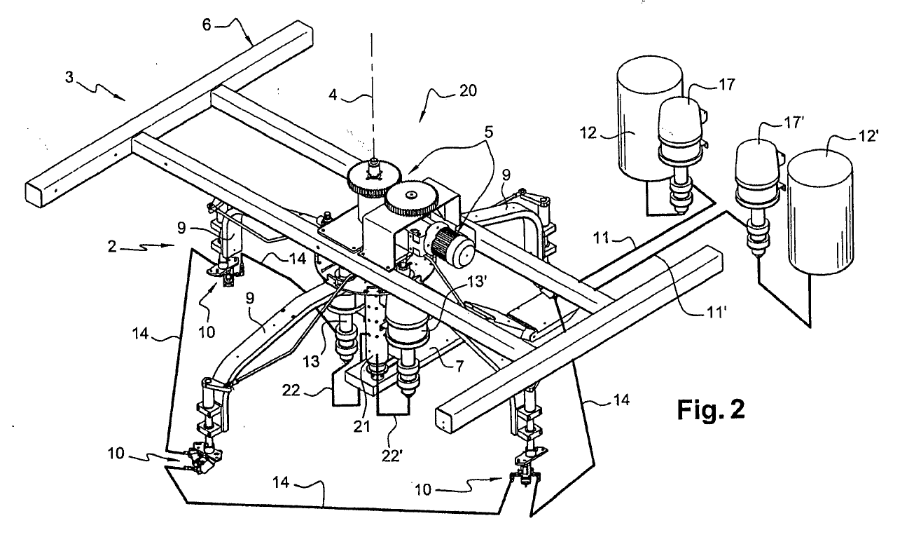

FIG. 1 shows by way of example a schematic of the spraying application device 1 having a spraying product. The spraying application device 1 includes a support 2 in the form of a rotary carousel, driven into rotation on a chassis 3 around an axis 4 by a motorized device 5, wherein the carousel is mounted between an upper frame 6 and a lower arm 7.

According to the invention, a spraying device 1 is intended to equip a gunning cabin, for spraying products such as paint, lacquer, varnish or any other treatment product. The carousel 2 is fitted with one or more spraying guns 10 for spraying the product. These spraying guns 10 can be composed of guns actuated by solenoid valves (not visible) controlled by an economizer jet; wherein the guns are adjusted according to certain operating parameters such as: the pressure of the spraying air, the pressure of the product, the width of the jet or positions and inclinations with respect to the object to be treated.

According to the invention, the spraying guns 10 can be arranged at the free end of the radial or radiated arms 9, in this particular example four have been represented, but there may be more or less in number. Further, rotating the carousel thereby causes the guns to move along a closed circular path. The guns 10 are supplied with pressurized product, due to pumps supplying pressure to a system including a set of pressurized feeding pipes.

A section of pipework 11, so-called “external pipework” ensures circulation of the product from a tank 12 to a main pump 13 on-board the rotary carousel 2. A pipework 14, so-called “on-board pipework” provides for the route of the spraying product to be applied from the pump 13 to the applicator guns 10. For example, the guns 10 are fed in series by the on-board pipework 14, but the supply may be performed in parallel or starwise, from the pump 13, without changing anything in the operating principle.

The on-board pump 13 can be mounted on the rotary carousel 2 so that its suction member 15, also called ‘suction stick’, is positioned on the rotational axis 4. At such level, the tight link between the suction stick 15 and the external pipework 11 is provided by a conventional connection system 16, here a simple channel rotary fitting, mounted on the rotational axis 4. The mobile section of this rotary fitting 16 is interconnected with the suction stick 15 of the on-board pump 13, and its fixed section is interconnected with the locking arm 7 aforementioned of the supporting chassis 3.

The center of gravity of the pump 13 is mounted on the axis 4 to ensure the rotational balance of the carousel 2.

FIG. 1 shows a second pump 17, so-called “supercharging pump”, mounted on the external pipework 11 or at the product tank 12. The supercharging pump 17 is not compulsory, but is able to provide in certain cases to cause the product sprayed to reach the on-board pump 13. The supercharging pump 17 may also be a conventional low pressure-type pump, operating at pressures of the order of 1 to 4 bars.

Because of the main on-board pump 13 possible operating conditions downstream of the rotary fitting 16, the main on-board pump 13 may be a conventional high pressure-type pump, operating at pressures above 40 bars (and up to 100-150 bars), in such a case, high pressure on-board pipework would be implemented.

In operation, the product to be sprayed progresses at low pressure through the external pipework 11, from the tank 12, because of the combined action of the supercharging pump 17 and of the on-board pump 13. Further, the spraying product runs through the rotary fitting 16, at low pressure, then circulates within the on-board pipework 14 where it is brought to a pressure by the on-board pump 13, to be sprayed by the applicator guns 10.

Consequently, the product to be applied runs at low pressure through the rotary fitting 16 and is then brought at high pressure, downstream of this rotary fitting 16, thereby enabling optimum spraying by the guns, without limiting the maximum pressure imposed by the structural features of said rotary fitting.

According to the invention, it possible due to space limitations or not, the on-board pump 13 may be off centered with respect to the rotational axis 4 of the carousel. In such a case, the suction member of the pump is connected to the rotary connection system 16 via a suitable channeling section which could be at low pressure.

FIG. 2 shows schematically a second spraying device 20, of rotary carousel type, according to another feature of the invention, which differs from FIG. 1, in that it includes two on-board pumps.

Accordingly, the structural elements common with the previous spraying device 1 are indicated by identical reference signs in the description of the second device 20.

According to the invention, a rotary carousel 2 is driven into rotation on a chassis 3 around an axis 4 by a motorized device 5. The rotary carousel 2 can be fitted with a spraying device formed of guns 10 mounted at the end of arms 9.

According to the invention, two low pressure-type supercharging pumps 17, 17′ supply the external pipes 11, 11′, each from a tank 12, 12′ to a multi-channel rotary fitting 21 mounted on the axis 4 of the carousel. This multi-channel fitting 21 supplies both on-board pumps 13 and 13′, for example of high pressure type, which cause one of the products to run from the tanks 12, 12′ to the guns 10, via the on-board piping system 14 (compatible with the pressures implemented).

For simplification purposes, the pipes linking the pump 13′ and the spraying guns 10 have not been represented on FIG. 2. On the other hand, as for the embodiment illustrated on FIG. 1, the guns 10 are supplied in series, but they might also be supplied starwise from each of both pumps 13 and 13′.

The gravity center of each on-board pump 13 and 13′, and their suction member, are misaligned with respect to the axis 4 of the rotary carousel. Both on-board pumps 13 and 13′ are mounted around this rotational axis 4 to ensure optimum rotational balance of the carousel. Appropriate pipes 22 and 22′, of low pressure type, link the multi-channel rotary fitting and the suction members of both pumps.

The mobile section of the rotary fitting 21 is interconnected with the carousel, whereas its fixed section is interconnected with the locking arm 7.

According to the invention, the pressure rise takes place after the rotary fitting 21, such that the pressures applied at the guns may be greater than 100 bars.

According to the invention, the number of pumps on-board the carousel may be more than two. Generally speaking, the number and/or the structural features of the pumps can be adapted in relation to the pressure and feeding conditions requested for the guns of each circuit.

In all cases, the features of the rotary fitting are suited to the number of pumps and to the different feeding circuits in presence.

1-10. (canceled)

11. A rotary carousel device for spraying a coloring and/or treatment product, the rotary carousel device comprising:
at least one rotary support rotatably driven by a motorized device on at least one chassis around a rotational axis;
one or more spraying devices in communication with a pressurized feeding system composed of at least one pump and a set of feeding pipes;
the set of feeding pipes comprising an on-board pipework arranged on the rotary carousel device, and an external pipework arranged to link the on-board pipework and at least one product tank;
a fitting or rotary seal connection system, mounted on the rotational axis, connecting the on-board pipework and the external pipework; and
the at least one pump being arranged on the rotary carousel device and being coupled to the external pipework and to the on-board pipework, to provide the product to a desired pressure at the spraying device.

12. The rotary carousel device in accordance with claim 11, wherein the at least one pump is coupled to the external pipework by dint of the connection system.

13. The rotary carousel device in accordance with claim 11, wherein the at least one pump is a pressure pump and the on-board pipework operates under a high pressure.

14. The rotary carousel device in accordance with claim 11, wherein the at least one pump is coupled to the one or more spraying devices through the on-board pipework under a high pressure.

15. The rotary carousel device in accordance with claim 11, wherein the at least one pump is a single pump having a suction member mounted along the rotational axis.

16. The rotary carousel device in accordance with claim 11, wherein a suction member and a center of gravity of the at least one pump are misaligned with respect to the rotational axis.

17. The rotary carousel device in accordance with claim 16, wherein the at least one pump comprises at least two pumps distributed regularly around the rotational axis to ensure the rotational balance.

18. The rotary carousel device in accordance with claim 11, wherein the at least one pump is a single pump connected to the external pipework through a single-channel rotary fitting.

19. The rotary carousel device in accordance with claim 15, wherein the at least one pump is connected to the external pipework through a multi-channel rotary fitting.

20. The rotary carousel device in accordance with claim 15, further comprising at least one low pressure pump coupled to the external pipework to supply product to the single pump.

21. The rotary carousel device in accordance with claim 11, further comprising a plurality of radial arms having free ends equipped with spraying devices.

22. The rotary carousel device in accordance with claim 21, wherein the spraying devices are composed of one or more guns actuatable by one or more solenoid valves.

23. The rotary carousel device in accordance with claim 11 is arranged within a gunning cabin.

24. A device comprising:
at least one rotary support driven by a motorized device to rotate on at least one chassis;
one or more spraying devices in communication with a pressurized feeding system, the feeding system comprising:
a set of feeding pipes forming an on-board pipework and an external pipework in communication with one or more tanks;
at least one pump arranged on the rotary support and connected between the external pipework and the on-board pipework.

25. The device in accordance with claim 24, wherein the device is a rotary carousel device for spraying a product.

26. The device in accordance with claim 24, wherein the device is a gunning cabin.

27. The device in accordance with claim 26, wherein the product is a coloring and/or treatment product.

28. The device in accordance with claim 24, wherein a fitting or rotary seal connection system connects the on-board pipework and the external pipework, and the connection system is mounted on a rotational axis of the rotary support.

29. The device in accordance with claim 24, wherein the at least one pump is a pressure pump and the on-board pipework is a pressure pipework operating at a high pressure.

30. The rotary carousel device in accordance with claim 24, wherein a center of gravity of the at least one pump and a suction member are misaligned with respect to a rotational axis of the rotary support.

31. The rotary carousel device in accordance with claim 24, wherein the at least one pump is a single pump connected to the external pipework by either a single-channel rotary fitting or multi-channel rotary fitting.

32. The rotary carousel device in accordance with claim 24, further comprising a plurality of radial arms coupled to the rotary support, the plurality of radial arms having free ends equipped with the one or more spraying devices.

33. A rotary carousel device for spraying a coloring and/or treatment product, the rotary carousel device comprising:
at least one rotary support rotatably driven on at least one chassis;
at least one pump mounted on the at least one rotary support;
one or more spraying devices in communication with a pressurized feeding system, such that the feeding system operates at a high pressure.

34. The device in accordance with claim 33, wherein the high pressure is greater than or equal to 40 bars.
